(19) United States
(12) Patent Application Publication
(10) Pub. No.: US 2018/0290887 A1
(43) Pub. Date: Oct. 11, 2018

(54) SOLAR ENERGY HARVESTING AND REVERSIBLE HYDROGEN STORAGE METHODS AND SYSTEMS

(71) Applicant: THE ROYAL INSTITUTION FOR THE ADVANCEMENT OF LEARNING/MCGILL UNIVERSITY, Montreal (CA)

(72) Inventors: Chao-Jun LI, Brossard (CA); Zetian MI, Verdun (CA); Lu LI, Montreal (CA)

(73) Assignees: THE ROYAL INSTITUTION FOR THE ADVANCEMENT OF LEARNING/MCGILL UNIVERSITY, Montréal, QC (CA); THE ROYAL INSTITUTION FOR THE ADVANCEMENT OF LEARNING/MCGILL UNIVERSITY, Montréal, QC (CA)

(21) Appl. No.: 15/575,039

(22) PCT Filed: May 19, 2016
(86) PCT No.: PCT/CA2016/050561

§ 371 Date: Nov. 17, 2017

Related U.S. Application Data
(60) Provisional application No. 62/163,425, filed on May 19, 2015.

(51) Int. Cl. C01B 3/00; B01J 21/06; B01J 23/52; B01J 23/42; B01J 23/46; B01J 23/44; B01J 35/00; B01J 37/02; B01J 19/12

(52) U.S. Cl. CPC C01B 3/0015; B01J 2219/0877; B01J 23/52; B01J 23/42; B01J 23/462; B01J 23/44; B01J 23/468; B01J 35/004; B01J 35/0013; B01J 35/0033; B01J 37/0221; B01J 19/127; B01J 2219/1203; B01J 2219/0892; B01J 21/063

(57) ABSTRACT

The present disclosure relates to a reversible hydrogen transfer process and storage system using visible light to photocatalytically generate hydrogen from compounds comprising saturated or partially saturated carbocyclic residue and catalytically hydrogenate compounds comprising at least one carbocyclic aromatic residue.

### FIELD OF THE DISCLOSURE

The present disclosure relates to a reversible hydrogen transfer process and storage system using visible light to photocatalytically generate hydrogen from compounds comprising saturated or partially saturated carbocyclic residue and catalytically hydrogenate compounds comprising at least one carbocyclic aromatic residue.

### BACKGROUND OF THE DISCLOSURE

Since the initial discovery of water photolysis on titanium dioxide (TiO₂ or titania) in the early 1970s the utilization of solar energy to either produce renewable fuels or trigger valuable transformations has become one of the most sustainable and promising strategies to solve the growing global concerns on energy supply and environmental issues, which are among the biggest challenges facing our society today. Hydrogen (H₂) is an attractive energy source, however, the problem of hydrogen storage and transportation is a major obstacle to employing hydrogen as a universal fuel since hydrogen has a very low volumetric density at ambient conditions. Storage and transportation of hydrogen currently requires using compressed hydrogen gas (30-70 MPa) or liquid hydrogen (−253° C.) in tanks.

Therefore, a technical problem resides in the design of a process and/or system that can both generate hydrogen or “store” hydrogen under practical conditions.

Other aspects and features of the present disclosure will become apparent to those ordinarily skilled in the art upon review of the following description of specific embodiments of the disclosure in conjunction with the accompanying figures.

### SUMMARY OF THE DISCLOSURE

In one aspect, there is provided a process comprising at least one step of:
a photo-driven catalyzed hydrogen (H₂) generation by dehydrogenation of a compound comprising at least one saturated or partially saturated carbocyclic residue; wherein said dehydrogenation is providing a compound comprising at least one carbocyclic aromatic residue; and
a catalyzed hydrogenation of a compound comprising at least one carbocyclic aromatic residue, wherein said hydrogenation is providing a compound comprising at least one saturated or partially saturated carbocyclic residue;
   wherein said catalyzed dehydrogenation and hydrogenation are conducted in the presence of a noble metal (metal) supported on semiconductor nanoparticles (NP) illustrated by the formula: metal@NP
   and wherein said photo-driven catalyzed dehydrogenation is conducted in the presence of visible light.

In one aspect, there is provided a process comprising a photo-driven catalyzed hydrogen (H₂) generation by dehydrogenation of a compound comprising at least one saturated or partially saturated carbocyclic residue; wherein said dehydrogenation is providing a compound comprising at least one carbocyclic aromatic residue;
wherein said catalyzed dehydrogenation is conducted in the presence of a noble metal (metal) supported on semiconductor nanoparticles (NP) illustrated by the formula:

metal@NP

and wherein said photo-driven catalyzed dehydrogenation is conducted in the presence of visible light.

In one aspect, there is provided a process comprising a catalyzed hydrogenation of a compound comprising at least one carbocyclic aromatic residue, wherein said hydrogenation is providing a compound comprising at least one saturated or partially saturated carbocyclic residue;

wherein said catalyzed hydrogenation is conducted in the presence of a noble metal (metal) supported on semiconductor nanoparticles (NP) illustrated by the formula:

metal@NP.

In one aspect, there is provided a process for preparing a noble metal (metal) supported on semiconductor nanoparticles (NP) illustrated by the formula:
metal@NP
   said process comprising chemically reducing a noble metal precursors of said noble metal, in the presence of semiconductor nanoparticles (NPs) in aqueous solution.

In one aspect, there is provided a noble metal (metal) supported on semiconductor nanoparticles (NP) illustrated by the formula:
metal@NP
   wherein said metal of said metal@NP is gold, silver, platinum, ruthenium, rhodium, palladium, osmium, iridium and combinations thereof.

In accordance with an aspect of the disclosure there is provided a method comprising: providing a device comprising:
a plurality of first nanostructures having a first predetermined geometry and formed from a first predetermined material composition, each first nanostructure having disposed upon its exterior surface or surfaces a plurality of second nanostructures having a second predetermined geometry and formed from a second predetermined material composition; and
providing within the device a predetermined fluid comprising at least a predetermined hydrocarbon; and

at least one of:
storing hydrogen within the predetermined fluid under first predetermined conditions (such as in an absence of visible light) such that the hydrogen is absorbed through a hydrogenation process with respect to the predetermined hydrocarbon; and
releasing hydrogen from the predetermined fluid under second predetermined conditions (such as in the presence of visible light) such that the hydrogen is released through a dehydrogenation process with respect to the predetermined hydrocarbon (such as an aromatic hydrocarbon).

In accordance with an embodiment of the disclosure there is provided a device comprising:
a plurality of first nanostructures having a first predetermined geometry and formed from a first predetermined material composition, each first nanostructure having disposed upon its exterior surface or surfaces a plurality of second nanostructures having a second predetermined geometry and formed from a second predetermined material composition; and
providing within the device a predetermined fluid comprising at least a predetermined hydrocarbon (such as an aromatic hydrocarbon); wherein
the device under first predetermined conditions (such as in the absence of visible light) stores hydrogen within the predetermined fluid such that the hydrogen is absorbed through a hydrogenation process with respect to the predetermined hydrocarbon; and
the device under second predetermined conditions releases (such as in the presence of visible light) hydrogen from the predetermined fluid such that the hydrogen is released through a dehydrogenation process with respect to the predetermined hydrocarbon.

Other aspects and features of the present disclosure will become apparent to those ordinarily skilled in the art upon review of the following description of specific embodiments of the disclosure in conjunction with the accompanying figures.

### BRIEF DESCRIPTION OF THE DRAWINGS

Embodiments of the present disclosure will now be described, by way of example only, with reference to the attached Figures, wherein:

FIG. 1A depicts schematically a catalyzed hydrogen addition and release to an organic cyclic hydrocarbon according to an embodiment of the disclosure;

FIG. 1B depicts the efficiencies of different noble metal catalyst activated nanoparticles for catalytic dehydrogenation of cyclohexane to benzene;

FIG. 2A depicts a low resolution TEM image showing Pt species dispersed on the surface of the TiO₂;

FIG. 2B depicts a high resolution TEM image showing Pt species dispersed on the surface of the TiO₂;

FIG. 2C depicts the Pt size distribution derived from TEM measurements;

FIG. 2D depicts powder X-ray diffraction (XRD) measurements of an embodiment of the disclosure;

FIG. 3A depicts the visible light driven dehydrogenation reactions of cyclohexane providing hydrogen and benzene using different embodiments of the disclosure;

FIG. 3B depicts the X-ray photoelectron spectroscopy (XPS) spectra for different embodiments of the disclosure;

FIG. 3C is a schematic representation of the possible mechanism involved in a process of the present disclosure;

FIG. 3D depicts the wavelength dependence of photocatalytic activity of embodiments of the disclosure;

FIG. 4 depicts a photocatalytic dehydrogenation mechanism for the dehydrogenation reactions of cyclohexane according to an embodiment of the disclosure; and

FIG. 5A depicts kinetic studies of hydrogen addition for certain organic cyclic hydrocarbons according to an embodiment of the disclosure;

FIG. 5B depicts kinetic studies of hydrogen release for certain organic cyclic hydrocarbons according to an embodiment of the disclosure; and

FIG. 5C depicts kinetic isotope effects in the dehydrogenation and hydrogenation processes.

### DETAILED DESCRIPTION

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It is being understood that various changes may be made in the function and arrangement of elements.

As used herein, the visible light is comprising (or consisting of) a wavelength greater than about 400 nm or greater than about 420 nm. Alternatively said visible light is comprising (or consisting of) a wavelength of from about 380 to about 800 nm, preferably about 420 to 700 nm, still more preferably about 420 to 600 nm.

As used herein, the aromatic residue (of “compound comprising at least one carbocyclic aromatic residue”) refers generally to a conjugated system comprising alternating single and double bonds in a ring allowing for the electrons in the molecule's pi system to be delocalized around the ring and wherein the number of said pi delocalized electrons meets the equation 4n+2, where n=is an integer (such as 1, 2, 3, . . . ).

In one embodiment, said carbocyclic aromatic residue is comprising a monocarbocyclic or polycarbocyclic aromatic ring, preferably a monocarbocyclic aromatic ring.

In one embodiment, the aromatic residue is comprising a benzo-fused residue such as benzofuran, isobenzofuran, indolem isoindole, indazole, benzimidazole, benzoxazole, benzisoxazole ect.

In one embodiment, said compound comprising at least one carbocyclic aromatic residue is comprising benzene, toluene, o, m and p-xylene, ethylbenzene. mesitylene, cumene, cymene or a mixture thereof.

In one embodiment, said “compound comprising at least one saturated or partially saturated carbocyclic residue” is in a substantially liquid state between about 5 to about 80° C., or from about 10 to 70° C. or from about 20 to about 50° C. or from about 20 to about 25° C.

In one embodiment, said “compound comprising at least one carbocyclic aromatic residue” is in a substantially liquid state between about 5 to about 80° C., or from about 10 to 70° C. or from about 20 to about 50° C. or from about 20 to about 25° C.

As used herein, the “compound comprising at least one saturated or partially saturated carbocyclic residue” are compounds corresponding to those obtained by saturating or partially saturating a “compound comprising at least one carbocyclic aromatic residue” as defined herein. Examples of these include cyclohexane/cyclohexene/cyclohexadiene (from benzene), methylcyclohexane/methylcyclohexene/methylcyclohexadiene (from toluene), 1,2-, 1,3- and 1,4-dimethylcyclohexane/dimethylcyclohexene/dimethylcyclohexadiene (from o-, m- and p-xylene). In one embodiment, said “compound comprising at least one saturated or partially saturated carbocyclic residue” is saturated, and preferably cyclohexane, methylcyclohexane, dimethylcyclohexane, or a mixture thereof. More preferably the compound is cyclohexane.

In one embodiment, said metal of said metal@NP is gold, silver, platinum, ruthenium, rhodium, palladium, osmium, iridium and combinations thereof.

In one embodiment, said metal of said metal@NP is gold, platinum, ruthenium, palladium, iridium and combinations thereof.

In one embodiment, said NP is comprising (or consisting of, or consisting essentially of) TiO₂, GaN, Al₂O₃ or a combination thereof. In one embodiment, said NP is comprising (or consisting of, or consisting essentially of) TiO₂.

In one embodiment, the wt % amount of said noble metal to said NP is from about 0.1 to 10%, or 0.1 to 5% or about 5%.

In one embodiment, said catalyzed dehydrogenation is conducted at a temperature lower than the boiling point and higher than the melting point of said “compound comprising at least one saturated or partially saturated carbocyclic residue”. In one embodiment, the temperature is from about 5 to about 80° C., or from about 10 to 70° C. or from about 20 to about 50° C. or from about 20 to about 25° C.

In one embodiment, said catalyzed hydrogenation is conducted at a temperature lower than the boiling point and higher than the melting point of said “compound comprising at least one carbocyclic aromatic residue”. In one embodiment, the temperature is from about 5 to about 80° C., or from about 10 to 70° C. or from about 20 to about 50° C. or from about 20 to about 25° C.

In one embodiment, said catalyzed hydrogenation is conducted in a reactor, wherein at least a portion of the reactor wall is a quartz wall. In one embodiment, said catalyzed hydrogenation is conducted in a photocatalytic glass reactors. In one embodiment, said catalyzed hydrogenation is conducted in a quartz reactor.

In one embodiment, said hydrogenation is conducted substantially in absence of visible light.

In one embodiment, said chemical reduction of said noble metal precursors is comprising a borohydride mediated reduction using a borohydride reagent. In one embodiment, said borohydride reagent is NaBH₄.

In one embodiment, said noble metal precursors and said nanoparticles (NPs) are contacted together in absence of light for a period of time before chemically reducing said precursor.

In one embodiment, said chemical reduction of said noble metal precursors comprising said borohydride reagent is conducted at an alkaline pH.

In one embodiment, said chemical reduction of said noble metal precursors comprising said borohydride reagent is conducted in the presence of an inorganic hydroxide-containing base, such as LiOH, NaOH, KOH etc.

In one embodiment, said NP of said metal@NP is comprising TiO₂, GaN, Al₂O₃ or a combination thereof. In one embodiment, said NP is comprising (or consisting of, or consisting essentially of) TiO₂.

In one embodiment, the wt % amount of said noble metal to said NP is from about 0.1 to 5% or about 5%.

A “catalyst” as used herein refers to, but is not limited to, a substance that starts or speeds up a chemical reaction while undergoing no permanent change itself although the catalyst may react with one or more reactants to form intermediates that subsequently give the final reaction product, in the process regenerating the catalyst. The chemical nature of catalysts is as diverse as catalysis itself although, for example, proton acids may be employed in many reactions involving water, including hydrolysis and its reverse. Other catalysts may include multifunctional solids, e.g. zeolites, alumina, higher-order oxides, graphitic carbon, nanoparticles, nanodots, and the facets of bulk materials; transition metals to catalyze reduction-oxidation (redox) reactions such as oxidation, hydrogenation; “late transition metals”, such as palladium, platinum, gold, ruthenium, rhodium, or iridium for example; and pre-catalysts which convert to catalysts in the reaction.

A “semiconductor” or “compound semiconductor” as used herein refers to, but is not limited to, a material having an electrical conductivity value falling between that of a conductor and an insulator wherein the material may be an elemental materials or a compound material. Semiconductors may include, but are not limited to:
Elements, such as certain group IV and group VI elements, e.g. silicon (Si) and germanium (Ge), and binary group IV alloys, e.g. silicon germanium (SiGe) and silicon carbide (SiC); III-V semiconductors, such as those between aluminum (Al), gallium (Ga), and indium (In) with nitrogen (N), phosphorous (P), arsenic (As) and tin (Sb), including for example GaN, GaP, GaAs, InP, InAs, AlN and AlAs;
II-VI semiconductors, such as cadmium selenide (CdSe), zinc oxide (ZnO), and zinc selenide (ZnS), for example;
I-VII semiconductors, IV-VI semiconductors, IV-VI semiconductors, V-VI semiconductors, II-V semiconductors, I-III-VI₂ semiconductors;
Oxides, layered semiconductors, magnetic semiconductors;
Organic semiconductors, which may include single molecules oligomers, organic polymers, and polycyclic aromatic hydrocarbons, for example; and,
Charge-transfer complexes, either organic or inorganic.

A “metal” as used herein refers to, but is not limited to, a material (an element, compound, or alloy) that have good electrical and thermal conductivity as a result of readily losing outer shell electrons which generally provides a free flowing electron cloud. This may include, but not be limited to, gold, chromium, aluminum, silver, platinum, nickel, copper, rhodium, palladium, tungsten, palladium, and combinations of such materials.

A “nanostructure” or “nanoparticle” as used herein refers to, but is not limited to, a structure having one or more dimensions at the nanometer level, which is typically between the lower and upper dimensions of 0.1 nm and 100 nm. Such structures, may include, nanotextured surfaces having one dimension on the nanoscale, nanotubes having two dimensions on the nanoscale, and nanoparticles having three dimensions on the nanoscale. Nanotextured surfaces may include, but not be limited, nano-grooves, nano-channels, and nano-ridges. Nanotubes may include structures having geometries resembling, but not be limited to, tubes, solid rods, whiskers, and rhomboids with square, rectangular, circular, elliptical, and polygonal cross-sections perpendicular to an axis of the nanotube. Nanoparticles may include structures having geometries representing, but not limited to, spheres, pyramids, and cubes. The cross-sectional geometry of nanotubes and nanoparticles may not be constant such that a nanostructure may taper in one or two dimensions.

A “nanowire” as used herein refers to, but is not limited to, a structure within the category of nanotubes by virtue of being nanoscale on two dimensions and solid cross-sectionally formed from one or more materials.

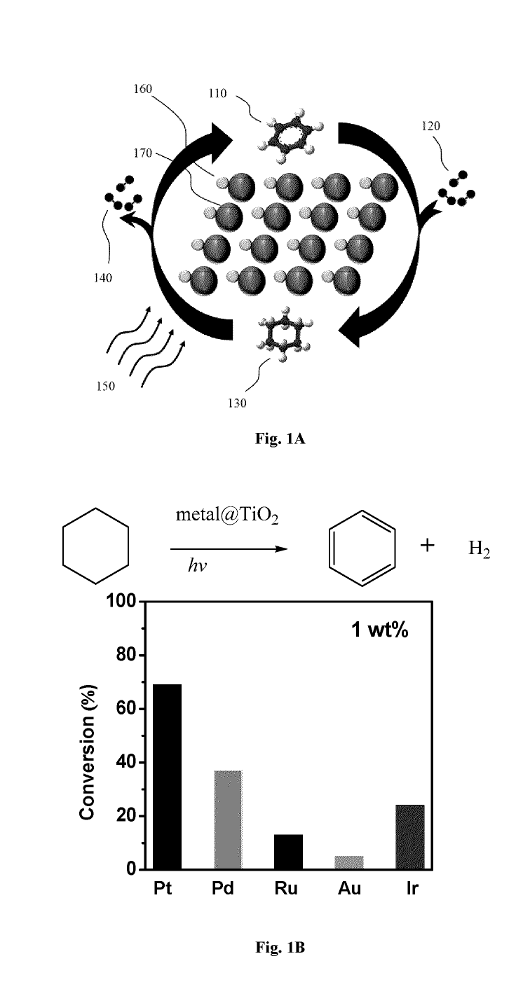

In order to achieve economical and high-density hydrogen storage it would be beneficial, preferable even, to provide a process, a noble metal supported catalyst or system providing a direct reversible hydrogen storage system. In this regard, the inventors have considered that a promising strategy is to add hydrogen to unsaturated aromatic hydrocarbons that contain only carbon and hydrogen atoms. For instance, benzene, the simplest aromatic, can “absorb” six hydrogen atoms to form cyclohexane through a metal catalyzed hydrogenation reaction. As benzene is one of the most widely used industrial petrochemicals, with 2012 production of approximately 43 million tons and expected to rise to 51 million tons in 2017, the bulk market price of benzene at <$1/kg is highly competitive with other hydrogen storage materials. Furthermore, both benzene and the cyclohexane produced as the hydrogen carrier, see FIG. 1A, are very stable and readily available for transportation using current liquid fossil fuel distribution infrastructure. However, this potential hydrogen storage system suffers from a severe limitation that the dehydrogenation of cyclohexane is highly endothermic. Owing to the large positive Gibbs free energy, an elevated temperature, >300° C., has been required for hydrogen release, which is not suitable for practical commercial and consumer applications and also inevitably results in the formation of coke.

However, the inventors have demonstrated that photoenergy is effective to overcome the intrinsic thermodynamic constraint of activating the C—H bonds of cyclic alkanes and provide easy stable hydrogen release under ambient conditions. Accordingly, referring to FIG. 1A there is depicted a reversible hydrogen storage/release cycle based on the metal-catalyzed hydrogenation and photoinduced dehydrogenation of organic cyclic hydrocarbons reactions at room temperature.

Referring to FIG. 1A benzene 110 is catalyzed in the presence of hydrogen 120 to form cyclohexane 130 at room temperature. This catalysis employing transition metal catalysts 160, for example, bound to titania nanoparticles 170, for example. Subsequently, under visible light irradiation 150 thereby releasing hydrogen 140 and yielding the original benzene 110. Importantly, the cleavage of six covalent C—H bonds of cyclohexane to form hydrogen and benzene stores comparable amount of energy as that of the water splitting reaction given in Equations (1) and (2), indicating a new approach to the concept of solar energy harvesting.

H₂O(g)→H₂(g)+½O₂(g)ΔH_{(298K)}=242 kJ·mol⁻¹ (1)

C₆H₁₂(g)→C₆H₆(g)+3H₂(g)ΔH_{(298K)}=206 kJ·mol⁻¹ (2)

In order to develop an efficient catalyst for the hydrogen release process under visible light, the inventors synthesized a series of noble metal, e.g. gold (Au), platinum (Pt), palladium (Pd), iridium (Ir), and rubidium (Ru) modified titania (TiO₂) nanoparticles (NPs). They were formed by chemically reducing the corresponding metal precursors in a sodium borohydride (NaBH₄) aqueous solution in the presence of commercial titania particles. These had a particle size of approximately 25 nm with Brunauer-Emmett-Teller (BET) surface area of approximately 55.2 m²g⁻¹ and an anatase—rutile phase ratio of approximately 4/1 at room temperature.

### Materials and Methods

Degussa P25 TiO₂ (particle size, ˜25 nm; Brunauer-Emmett-Teller (BET) surface area, 55.2 m2g-1; anatase/rutile phase ratio, 4/1) were purchased from Sigma-Aldrich and used without further treatment. All commercially available compounds were purchased from Sigma-Aldrich, Strem and Across Company, and used without further purification.

### Chemical Reduction

The metallic Au⁰, Pt⁰, Pd⁰, Ir⁰ and Ru0-modified TiO₂ (or GaN, Al₂O₃) catalysts were obtained through chemically reducing the corresponding metal precursors in a NaBH₄ aqueous solution. In a typical synthesis, 0.2 g of TiO₂ powders was added into 50 mL of aqueous solution (1-10 wt % metal) of H₂AuCl₆, H₂PtCl₆, PdCl₂, H₂IrCl₆ and RuCl₃, respectively, followed by stirring under darkness overnight. Then, 5 mL of NaBH₄ (0.02-0.2 M) and NaOH (0.02-0.2 M) solution was slowly added into the gel mixture under vigorous stirring at 20° C. After one hour reduction, the materials were washed in deionized water and dried in an oven at 110° C. for 5 hrs.

### Photo-Reduction

A certain amount of chloroplatinic acid (H₂PtCl₆, Sigma Aldrich), 0.2 g of TiO₂, 12 mL of CH₃OH, and 60 mL of water were added in a 460 mL Pyrex chamber (Kimble Chase) with quartz lid. The chamber was evacuated for 10 min in order to remove the dissolved O₂, and subsequently irradiated using 300 W xenon lamp (PerkinElmer, PE300BF) for 30 min under vigorous stirring for photoassisted deposition of metallic Pt species. After reduction, the materials were washed in deionized water and dried in an oven at 110° C. for 5 hrs.

### Hydrogen Release and Storage

Photo-Driven Alkane Dehydrogenation Reaction (Hydrogen Release) 10 mg of the metal-modified substrate was spread evenly on the bottom of a closed quartz reactor and then evacuated at 250° C. for 1 h to remove the water and other molecules adsorbed on the surface of the sample. Afterwards, the reactor was cooled slowly to room temperature under vacuum (P<1 Pa), followed by the reaction with 100 μmol of pure cyclohexane (or other cyclic alkanes) under visible irradiation from a 300 W xenon lamp.

### Aromatic Hydrogenation Reaction (Hydrogen Storage)

10 mg of the metal-modified substrate was spread evenly on the bottom of a closed quartz reactor and then evacuated at 250° C. for 1 h to remove the water and other molecules adsorbed on the surface of the sample. Afterwards, the reactor was cooled slowly to room temperature (or 50° C.) under vacuum (P<1 Pa), followed by the introduction of 300 μmol of hydrogen gas and 100 μmol of benzene (or other aromatics) under darkness.

### General Characterization

The powder X-ray diffraction (XRD) patterns were recorded on a Bruker D8 Advanced Diffractometer with Cu Kα radiation (λ=1.5418 Å). High resolution bright field transmission electron microscope (TEM) images were obtained using FEI Tecnai G2 F20 S/TEM at accelerating voltage of 200 kV. The Brunauer-Emmett-Teller (BET) surface areas of the samples were measured from the adsorption of N2 at 77 K by using a Micromeritics ASAP 2020M system. The X-ray photoelectron spectroscopy (XPS) was performed on an ESCALAB 250 X-ray photoelectron spectrometer with a monochromated X-ray source (Al K·h·=1486.6 eV). The energy scale of the spectrometer was calibrated using Au4f7/2, Cu2p3/2, and Ag3d5/2 peak positions. The standard deviation for the binding energy (BE) values was 0.1 eV.

### Carbon Balance

The calculation of the carbon balance during the photocatalytic cyclohexane dehydrogenation reaction was carefully performed based on the ratio of carbon output (methane, benzene, CO₂, recovered cyclohexane) to carbon input (cyclohexane), see equation ES1:

$$Carbon balance = \frac{Moles of products in terms of carbon}{Moles of converted cyclohexane in terms of carbon} \times 100 \% \qquad ( ES1 )$$

Calculation of Conversion and Selectivity

The conversion of cyclohexane is defined as the ratio of moles of cyclohexane consumed in the reaction to the total moles of cyclohexane initially added (Eq. ES2). The selectivity to benzene is defined as the ratio of moles of benzene produced to the total moles of all hydrocarbon products in terms of carbon (Eq. ES3).

$$\begin{matrix}Conversion of cyclohexane = \frac{Moles of cyclohexane consumed}{Moles of cyclohexane intially added} \times 100 \% & ( ES2 ) \\ Selectivity of benzene = \frac{Moles of benzene produced in terms of carbon}{Moles of all hydrocarbon products in terms of carbon} \times 100 \% & ( ES3 )\end{matrix}$$

Methane, ethane, cyclohexene and benzene were the only products observed. Therefore, we calculated the conversion and selectivity using the GC traces without the internal standard in order to avoid the error originated from the internal standard.

### Calculation of Apparent Quantum Efficiency

In principle, it takes two photons to produce each hydrogen molecule from cyclohexane molecules. Thus, in turn, six photons are needed to produce one benzene molecule.

The as-synthesized metal@TiO₂ hybrid materials were tested as photocatalysts for the non-oxidative dehydrogenation of cyclohexane under visible light (420 nm≤λ≤700 nm) from a 300 W xenon lamp. To eliminate photo-thermal effects, a cooling system was employed to keep the reaction temperature constant at 20° C. Amongst the noble metal@TiO₂ hybrid materials synthesized and tested Pt@TiO₂ NPs gave the highest photocatalytic activity for the dehydrogenation reaction among all the samples tested under identical conditions as evident from FIG. 1B.

The inventors then proceeded to further optimize Pt@TiO₂ NPs by altering the Pt content, NaBH₄ concentration and pH value during the preparation procedure. The results of varying these parameters can be seen in Table 1.

TABLE 1
Pt@TiO₂ Optimization for Photocatalytic Dehydrogenation of Cyclohexane

| | TiO₂ | Pt Loading | NaBH₄ | NaOH | Reaction Time | Conversion | TOF |
|---|---|---|---|---|---|---|---|
| Entry | (mg) | (wt %) | (Equiv.)^{†} | (μmol) | (hour) | (%) | (h⁻¹) |
| 1 | 200 | 0.1 (1 μmol) | 10 | 100 | 24 | 4 | 3.3 |
| 2 | 200 | 0.2 (2 μmol) | 10 | 100 | 24 | 12 | 5.0 |
| 3 | 200 | 0.5 (5 μmol) | 10 | 100 | 24 | 40 | 6.7 |
| 4 | 200 | 1 (10 μmol) | 10 | 100 | 24 | 69 | 5.8 |
| 5 | 200 | 2 (20 μmol) | 10 | 100 | 24 | 71 | 3.0 |
| 6 | 200 | 5 (50 μmol) | 10 | 100 | 24 | 80 | 1.3 |
| 7 | 200 | 5 (50 μmol) | 10 | 100 | 2 | 7 | 1.5 |
| 8 | 200 | 5 (50 μmol) | 10 | 125 | 2 | 43 | 8.5 |
| 9 | 200 | 5 (50 μmol) | 10 | 200 | 2 | 83 | 17 |
| 10 | 200 | 5 (50 μmol) | 20 | 200 | 2 | 91 | 18 |
| 11 | 200 | 5 (50 μmol) | 20 | 250 | 2 | 99 | 20 |
| 12^{‡} | 200 | 5 (50 μmol) | 20 | 250 | 2 | NP | 0 |

*Reaction conditions: 10 mg of Pt@TiO₂—N and 100 μmol of cyclohexane were used under visible light irradiation at 20° C.
^{†}in terms of Pt loading
^{‡}Dark Reaction.
TOF = turnover frequency (based on the amount of Pt).
NP = no product.

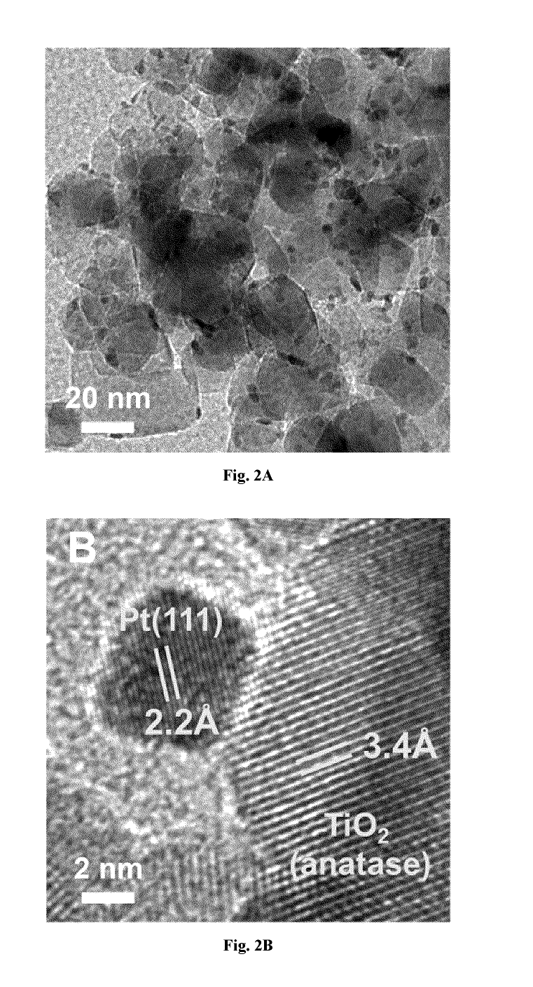

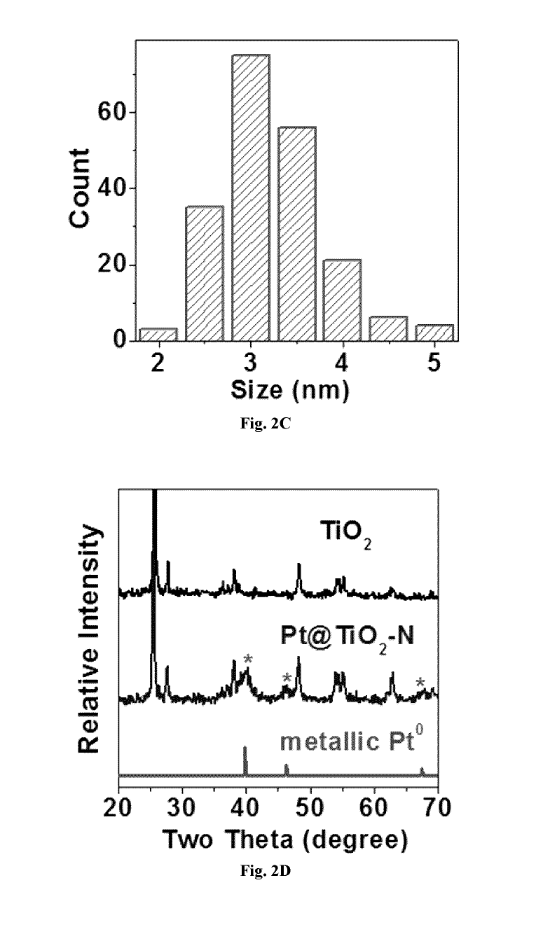

Finally, the optimized Pt@TiO₂ NPs with a platinum content of 5 wt % were carefully prepared by using 20 equiv. of NaBH₄ (in terms of platinum) at pH 10, designated as Pt@TiO₂—N. Transmission electron microscopy (TEM) images, such as those depicted in first and second images A and B in FIG. 2 at low and high resolution respectively revealed that Pt species were highly dispersed on the surface of the TiO₂ NPs with an exposed (111) facet. The Pt size distribution derived from TEM measurements fits well in a logarithmic normal distribution with a mean diameter of 3.2 nm as evident from first graph C in FIG. 2. Further, powder X-ray diffraction (XRD) measurements confirmed the formation of metallic Pt⁰ species with a high degree of crystallinity since three characteristic peaks of Pt⁰ at 2θ=41°, 46°, 67° were clearly observed as evident with second graph D in FIG. 2.

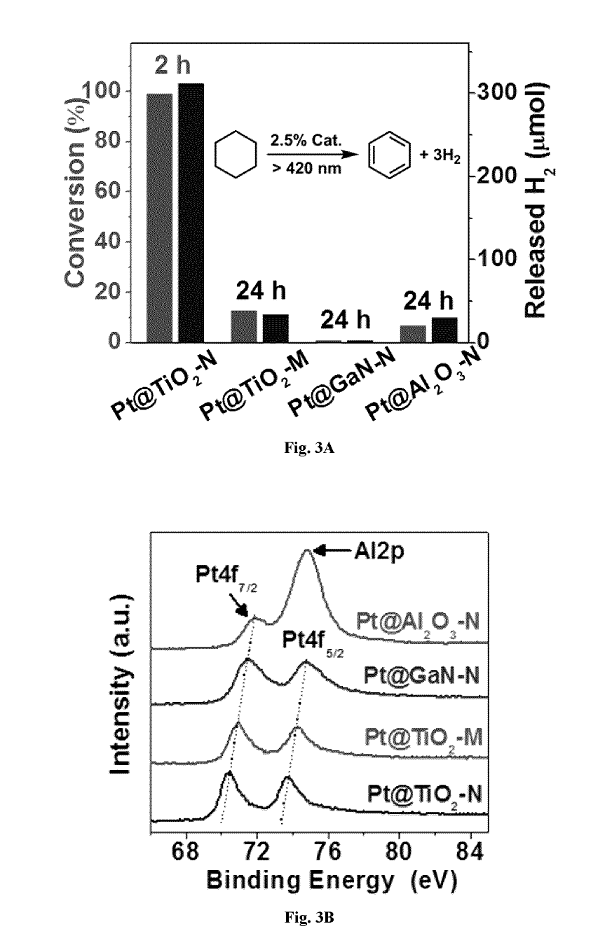

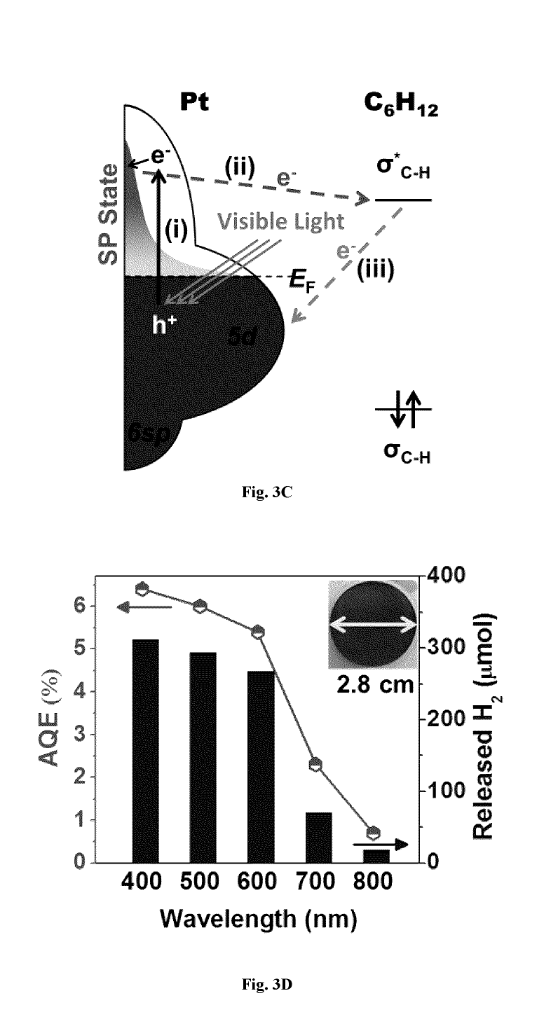

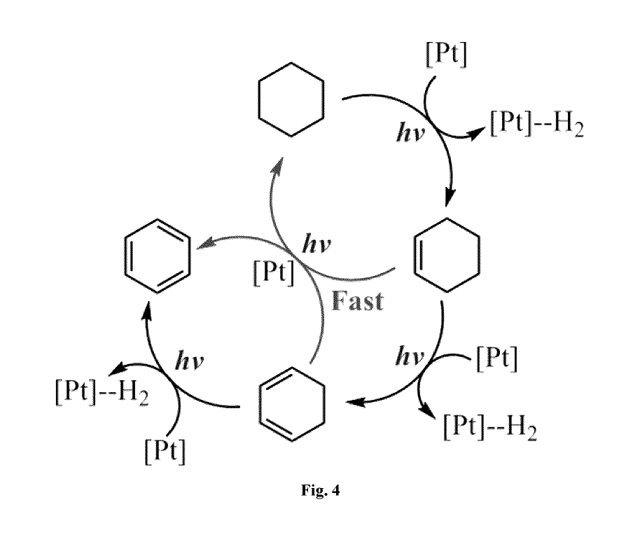

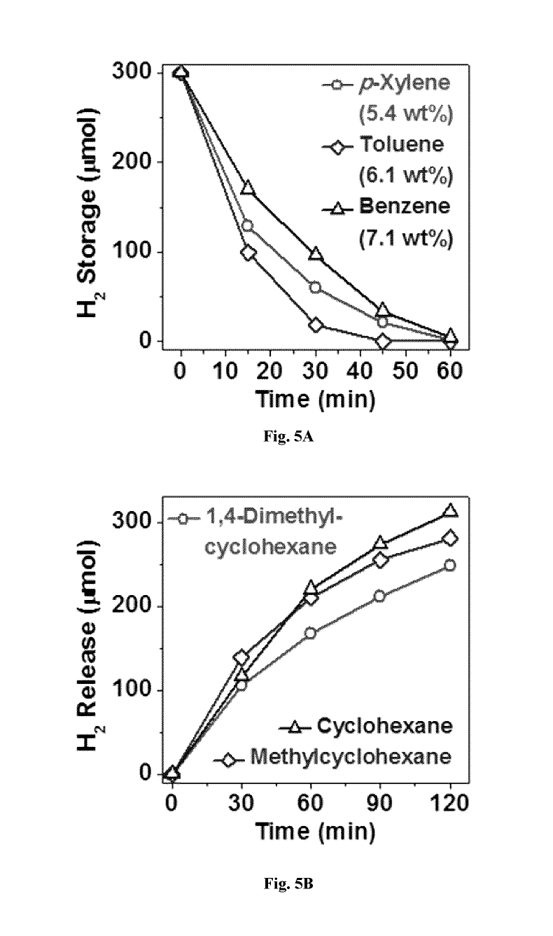

The photocatalytic cyclohexane dehydrogenation reaction over the optimal Pt@TiO₂—N led to the formation of benzene with nearly stoichiometric amounts of H₂ (3 equiv.). Using 10 mg of Pt@TiO₂—N and 100 μmol of cyclohexane, a conversion of 99% and a benzene selectivity of nearly 100% was achieved after 2 hour visible light irradiation as evident from first graph A in FIG. 3. The carbon mass balances during the conversion were close to 100% and only a trace amount of methane and carbon dioxide by-products were detected by gas chromatography. The control experiments have shown that the reaction does not proceed at all in the dark or in the absence of the Pt species (exemplified by using pure TiO₂), confirming that the dehydrogenation of cyclohexane to benzene by Pt @ TiO₂—N is a photocatalytic process and the Pt species behave as the active sites for reaction.

To gain a better understanding of the nature of the catalytic active sites, the inventors also prepared another Pt modified TiO₂ through the photo-reduction of PtCl₆²⁻ precursor in a mixture of methanol/water solution (designated as Pt @ TiO₂-M). Here, although the content, shape and size of Pt species in Pt @ TiO₂-M are similar to those in Pt @ TiO₂—N, as confirmed by TEM and XRD measurements, the photoactivity of Pt @ TiO₂-M, however, was very low for cyclohexane dehydrogenation under the same reaction conditions, first graph A in FIG. 3. As evident from X-ray photoelectron spectroscopy (XPS) spectra presented in second graph B in FIG. 3, the Pt^{4f} peaks of Pt @ TiO₂—N are negatively shifted (70.4 eV) compared to the standard binding energies of metallic Pt⁰ (71.1 eV), indicating that the Pt species in Pt A TiO₂—N possess a fraction of negative charge which may be caused by the strong reducing ability of NaBH₄; whereas the Pt^{4f} peaks of Pt @ TiO₂-M remain almost unchanged (71.0 eV). These results imply that the Pt species with high electron density, which can act as Lewis base sites, are highly beneficial to the dehydrogenation process.

Besides TiO₂, GaN and Al₂O₃ were also used as supporting-substrates for the cyclohexane dehydrogenation reaction. The performance of the tested Pt @ GaN—N and Pt A Al₂O₃—N catalyst is shown in first graph A in FIG. 3. Although the conversion was lower than for Pt @ TiO₂—N, under visible light irradiation, (despite the fact that the band gap and band position of GaN are similar to TiO₂), the use of GaN and Al₂O₃ may be justified in certain circumstances, or their respective performances may still be optimized. The binding energy of Pt deposited on GaN or Al₂O₃ is also higher than that on TiO₂, as evidenced by the XPS results presented in second graph B in FIG. 3. These results indicate that the interaction between metal and support could significantly alter the electronic and catalytic properties of loaded Pt species.

Nanosized Pt are visible-light-active species due to intra-band electron transitions whereas TiO₂ substrate can only absorb photons in the ultraviolet region. Therefore, the metallic Pt species essentially act as both sensitizers to absorb resonant photons, and active sites to facilitate the dehydrogenation reactions. As illustrated in schematic C in FIG. 3, upon visible light irradiation, the photoexcited hot electrons of Pt species can be temporarily added to an empty C—H σ*-antibonding orbital of the adsorbed cyclohexane to actively and homolytically cleave its C—H bond, followed by the formation of an H atom which then couples with another H atom to produce H₂. It is worth noting that the alkane dehydrogenation process does not consume extra electrons and thus, the photoexcited electrons will finally fall back to Pt. This mechanism is consistent with the experimental and XPS results that the Pt species with high electron density (low electron binding energy), which can offer electrons efficiently, are critical to access a high reactivity to the cyclohexane dehydrogenation reaction under visible light.

In order to identify the effective spectral range and quantum efficiency, wavelength dependence experiments were carried out using a series of filters. As shown in third graph D in FIG. 3, the photocatalytic activity still remains at a high level around λ≈600 nm, but decreased dramatically when the wavelength of light irradiation was longer than λ>700 nm. The apparent quantum efficiency (H₂ produced per photon consumed) between 420 nm 600 nm was calculated to be approximately 6.0%, which rivals previously reported best performing solar water splitting devices without any external bias voltage by one of the inventors.

During the cyclohexane dehydrogenation reaction, only the cyclohexene intermediate was observed, whereas 1,3-cyclohexadiene was not detected. The control experiments indicate that 1,3-cyclohexadiene can either directly lose hydrogen to form benzene or react with cyclohexene to form benzene and cyclohexane over Pt@TiO₂—N under visible light irradiation. Both reactions are extremely fast (within few seconds). Taken together, a proposed mechanism is depicted in FIG. 4. The reaction starts with the activation of cyclohexane C—H bonds on the exposed Pt facets. Upon visible light irradiation, cyclohexane loses two hydrogen atoms to form cyclohexene. 1,3-cyclohexadiene produced from the further dehydrogenation of cyclohexene can quickly go through the dehydrogenation process or react with cyclohexene to form benzene.

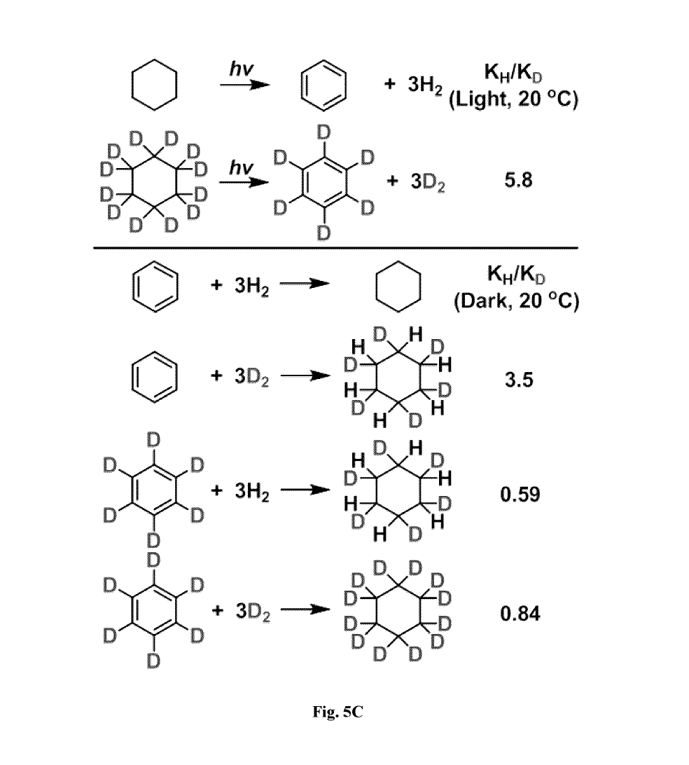

After the dehydrogenation reaction, the produced hydrogen can very slowly add back into benzene to form cyclohexane again under no illumination at room temperature in the presence of Pt@TiO₂—N. In contrast, no hydrogenation product was obtained in the absence of Pt @ TiO₂—N. The hydrogenation process can be accelerated dramatically at slightly higher temperatures. As depicted in first graph A in FIG. 5 a hydrogenation conversion of 97% can be achieved within one hour at 50° C. Furthermore, toluene/methylcyclohexane and xylene/1,4-dimethylcyclohexane systems also work well for hydrogen storage and release as evident from the results depicted in first and second graphs A and B respectively in FIG. 5 under the same conditions, indicating a wide applicability of embodiments of the disclosure for a reversible hydrogen storage system exploiting low cost hydrocarbons.

As depicted in first graph A in FIG. 5 the time curves of hydrogen addition (300 μmol) onto different aromatics (100 μmol) over Pt@TiO₂—N under dark conditions at 50° C. are plotted. Corresponding hydrogen release curves for these different cyclic alkanes (100 μmol) as a function of time over Pt@TiO₂—N under visible light irradiation (λ>420 nm) at 20° C. are depicted in second graph B in FIG. 5. Schematic C in FIG. 5 depicts kinetic isotope effects in the dehydrogenation and hydrogenation processes.

To gain the mechanistic insights of different hydrogen transfer steps, the deuterium kinetic isotope effects (KIE) for both dehydrogenation and hydrogenation processes were determined comprehensively, as depicted in schematic C in FIG. 5. In the case of the dehydrogenation reaction, a high KIE (k_{H}/k_{D}) of 5.8 was determined through parallel reactions by using the same amount of cyclohexane and cyclohexane-d₁₂ (C₆D₁₂), indicating that the C—H bond cleavage is the rate-determining step. In contrast, kinetic studies for the hydrogenation reaction were performed by using four different combinations including benzene/H₂, benzene/D₂, benzene-d₆/H₂ and benzene-d₆/D₂. The hydrogenation rate of benzene/D₂ was much lower than that of benzene/H₂ (k_{H}/k_{D}=3.5), whereas a large inverse secondary isotope effect was observed in benzene-d₆/D₂ (k_{H}/k_{D}=0.59) since the hybridization of carbon changes from sp² to sp³ during the reaction. In benzene-d₆/D₂ case, the overall KIE value is close to one since both primary isotope and inverse secondary isotope effects exist in the system which can neutralize each other to a certain extent.

Accordingly, embodiments of the invention described supra show that abundant and low-cost petrochemicals can form the basis of large scale reversible hydrogen storage/release without any external requirements. Accordingly, a reversible hydrogen storage/release assembly may be employed in conjunction with a visible light based hydrogen generator. Importantly, such a stable and scalable hydrogen storage/release system can be seamlessly integrated with solar energy harvesting under practical conditions, i.e., with the use of only visible light at ambient temperature. The apparent quantum efficiency for solar-to-hydrogen conversion can reach 6% under white light illumination, which can be further improved by optimizing the photon absorption. Embodiments of the disclosure provide for an entirely new strategy to effectively address the twin problems associated with the emerging hydrogen economy, including hydrogen storage and solar-to-hydrogen conversion.

Within the embodiments of the disclosure described and depicted supra noble metal catalysts were employed in conjunction with nanoparticles (such as TiO₂).

It would be evident to one of skill in the art that in other embodiments of the disclosure other noble metals that those listed above may be used. Such catalysts may be formed, for example, as nanoparticles upon TiO₂ nanoparticles or as other structures upon or as part of the nanoparticles or other material nanoparticles, 2D nanostructures, and 3D nanostructures without departing from the scope of the disclosure.

It would be evident to one of skill in the art that rather than nanoparticles that other types of TiO₂ substrates in the form of nanorods, nanotubes and films may also be applied to form supporting structures for catalysts and provide good activities towards both the hydrogen addition and release processes. In addition, besides TiO₂, graphene oxide, graphene sheets and graphene nanoribbons may also be employed as supporting materials for the cyclohexane dehydrogenation and benzene hydrogenation reactions, especially in liquid solutions. Within other embodiments of the disclosure semiconductors may be employed to form the nanostructures supporting catalysts.

In one embodiment of the method described herein, said method is further comprising performing a cyclic process of storing hydrogen and releasing hydrogen such the predetermined hydrocarbon is initially converted to another hydrocarbon on the basis of the hydrogenation reaction during the storing sequence and then the another hydrocarbon is converted back to the predetermined hydrocarbon on the basis of the dehydrogenation reaction during the releasing sequence.

In one embodiment of the method described herein, said method is performing a cyclic process of storing hydrogen and releasing hydrogen, wherein the hydrogen store within the device is generated though visible light splitting of water.

In one embodiment of the method described herein,
at least one of:
the plurality of first nanostructures are at least one of a two-dimensional (2D) nanostructure and a three-dimensional (3D) nanostructure;
the plurality of second nanostructures are at least one of a two-dimensional (2D) nanostructure and a three-dimensional (3D) nanostructure;
the plurality of first nanostructures are formed from a catalyst selected in dependence upon at least the predetermined hydrocarbon and another hydrocarbon such that the predetermined hydrocarbon and another hydrocarbon are either the results of the hydrogenation and dehydrogenation reactions respectively or the dehydrogenation and hydrogenation reactions respectively;
the second predetermined material composition is a noble metal, a transition metal, a combinations of noble metals, a combination of transition metals, and a noble metal—transition metal combination;
the first predetermined material composition is at least one of titania, graphite, graphene, and semiconductor.

The foregoing disclosure of the exemplary embodiments of the present disclosure has been presented for purposes of illustration and description. It is not intended to be exhaustive or to limit the disclosure to the precise forms disclosed. Many variations and modifications of the embodiments described herein will be apparent to one of ordinary skill in the art in light of the above disclosure. The scope of the disclosure is to be defined only by the claims appended hereto, and by their equivalents.

Further, in describing representative embodiments of the present disclosure, the specification may have presented the method and/or process of the present disclosure as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible.

1. A process comprising at least one of:
a photo-driven catalyzed hydrogen (H₂) generation by dehydrogenation of a compound comprising at least one saturated or partially saturated carbocyclic residue; wherein said dehydrogenation is providing a compound comprising at least one carbocyclic aromatic residue; and
a catalyzed hydrogenation of a compound comprising at least one carbocyclic aromatic residue, wherein said hydrogenation is providing a compound comprising at least one saturated or partially saturated carbocyclic residue;
wherein said catalyzed dehydrogenation and hydrogenation are conducted in the presence of a noble metal (metal) supported on semiconductor nanoparticles (NP) illustrated by the formula:
metal@NP
and wherein said photo-driven catalyzed dehydrogenation is conducted in the presence of visible light.

2. The process of claim 1, wherein said visible light is comprising a wavelength greater than about 400 nm.

3. The process of claim 1, wherein said carbocyclic aromatic residue is comprising a monocarbocyclic or polycarbocyclic aromatic ring.

4. The process of claim 1, wherein said compound comprising at least one carbocyclic aromatic residue is in a substantially liquid state between about 5 to about 80° C.

5. The process of claim 1, wherein said compound comprising at least one carbocyclic aromatic residue is comprising benzene, toluene, o-, m- or p-xylene, ethylbenzene. mesitylene, cumene, cymene or a mixture thereof.

6. The process of claim 1, wherein said compound comprising at least one saturated or partially saturated carbocyclic residue is in a substantially liquid state between about 5 to about 80° C.

7. The process of claim 1, wherein said compound comprising at least one saturated or partially saturated carbocyclic residue is cyclohexane, cyclohexene, cyclohexadiene methylcyclohexane, methylcyclohexene, methylcyclohexadiene, 1,2-, 1,3- and 1,4-dimethylcyclohexane, dimethylcyclohexene, dimethylcyclohexadiene or a combination thereof.

8. The process of claim 1, wherein said compound comprising at least one saturated or partially saturated carbocyclic residue is a saturated carbocyclic compound.

9. The process of claim 1, wherein said metal of said metal@NP is gold, silver, platinum, ruthenium, rhodium, palladium, osmium, iridium or a combination thereof.

10. The process of claim 1, wherein said NP is comprising TiO₂, GaN, Al₂O₃ or a combination thereof.

11. The process of claim 1, wherein said catalyzed dehydrogenation is conducted at a temperature of from about 5 to about 80° C.

12. The process of claim 1, wherein said catalyzed hydrogenation is conducted at a temperature of from about 5 to about 80° C.

13. A process for preparing a noble metal (metal) supported on semiconductor nanoparticles (NP) illustrated by the formula:
metal@NP
said process comprising chemically reducing a noble metal precursor of said noble metal, in the presence of semiconductor nanoparticles (NPs) in aqueous solution.

14. The process of claim 13, wherein said noble metal precursor and said nanoparticles (NPs) are contacted together in absence of light for a period of time before chemically reducing said precursor.

15. The process of claim 13, wherein said chemical reduction of said noble metal precursor is comprising a borohydride-mediated reduction conducted at an alkaline pH.

16. A noble metal (metal) supported on semiconductor nanoparticles (NP) illustrated by the formula:
metal@NP
wherein said metal of said metal@NP is gold, silver, platinum, ruthenium, rhodium, palladium, osmium, iridium and combinations thereof.

17. The noble metal (metal) supported on semiconductor nanoparticles (NP) of claim 16, wherein said NP of said metal@NP is comprising TiO₂, GaN, Al₂O₃ or a combination thereof.
